(19) United States
(12) Patent Application Publication
(10) Pub. No.: US 2009/0195504 A1
(43) Pub. Date: Aug. 6, 2009

(54) Optical Pointing Device

(76) Inventors: Hui-Hsuan Chen, Hsinchu (TW); Tien-Chia Liu, Hsinchu (TW); Hung-Ching Lai, Hsinchu (TW)

Correspondence Address: HDLS Patent & Trademark Services, P.O. BOX 220746, CHANTILLY, VA, 20153-0746, US

(21) Appl. No.: 12/108,800

(22) Filed: Apr. 24, 2008

(30) Foreign Application Priority Data
Feb. 1, 2008 (TW) 097104005

(51) Int. Cl. G06F 3/033

(52) U.S. Cl. 345/166

(57) ABSTRACT

An optical pointing device includes a light source, a light beam splitter, an image sensor and a lens. The light source provides an illumination light beam. The light beam splitter is disposed on a transmission path of the illumination light beam and configured for splitting the illumination light beam into a first light beam and a second light beam. The image sensor is for sensing the first and the second light beams. The lens is disposed before the image sensor. When the optical pointing device is put on a reflective surface, the first light beam is reflected to the lens by the reflective surface and then is focused on the image sensor. When the optical pointing device is put on a transparent body disposed on the reflective surface, the second light beam is reflected to the lens by the reflective surface and then is focused on the image sensor.

### BACKGROUND

1. Technical Field

The present invention generally relates to a pointing device and, particularly, to an optical pointing device.

2. Description of the Related Art

An optical mouse is a type of commonly used pointing device for moving a cursor displayed on a computer screen. Generally, the optical mouse is put on a reflective surface. A light beam provided by a light source of the optical mouse is reflected to an image sensor of the optical mouse by the reflective surface, therefore when the optical mouse is moved, the cursor displayed on the screen would correspondingly move on the screen. However, when the optical mouse is put on a transparent body which is disposed on a reflective surface, a transmission path of the light beam provided by the optical mouse would be refracted by the transparent body. Therefore, the light beam can't be accurately focused on the image sensor. As a result, the sensitivity of the optical mouse is severely degraded.

FIGS. 1A and 1B respectively illustrate a conventional optical mouse being put on an opaque body and being put on a transparent body. As illustrated in FIGS. 1A and 1B, in order to overcome the above-mentioned drawback, an optical mouse 100 is proposed. The optical mouse 100 includes a light source 110, a first lens 120, a second lens 130 and an image sensor 140. The light source 110 is for providing a light beam 112. The first lens 120 and the second lens 130 are disposed before the image sensor 140.

Referring to FIG. 1A, when the optical mouse 100 is put on a reflective surface 50 (i.e., opaque body), the light beam 112 is reflected to the first lens 120 by the reflective surface 50 and then is focused on the image sensor 140 by the first lens 120.

Referring to FIG. 1B, when a transparent body 60 (e.g., glass) is disposed on the reflective surface 50 and the optical mouse 100 is put on the transparent body 60, the light beam 112 would firstly pass through the transparent body 60 and then is reflected by the reflective surface 50. Since the refraction phenomenon occurs at both of the circumstances of the light beam 50 entering into the transparent body 60 and exiting from the transparent body 60, therefore the second lens 130 is disposed on a transmission path of the light beam 112 exited from the transparent body 60 to focus the light beam 112 on the image sensor 140.

### BRIEF SUMMARY

The present invention provides an optical pointing device having good sensitivity even if the optical pointing device is put on a transparent body disposed on a reflective surface.

In order to achieve the above-mentioned advantage, an optical pointing device in accordance with an embodiment of the present invention is provided. The optical pointing device includes a light source, a light beam splitter, an image sensor and a lens. The light source is configured (i.e., structured and arranged) for providing an illumination light beam. The light beam splitter is disposed on a transmission path of the illumination light beam and configured for splitting the illumination light beam into a first light beam and a second light beam. The image sensor is configured for sensing the first light beam and the second light beam. The lens is disposed before the image sensor. Furthermore, when the optical pointing device is put on a reflective surface, the first light beam is reflected to the lens by the reflective surface and then is focused on the image sensor. When the optical pointing device is put on a transparent body which is disposed on the reflective surface, the second light beam is reflected to the lens by the reflective surface and then is focused on the image sensor.

In one embodiment of the present invention, the light beam splitter is a prism or a grating.

In one embodiment of the present invention, the optical pointing device further includes a reflection element disposed on a transmission path of the second light beam and configured for reflecting the second light beam to the reflective surface.

In one embodiment of the present invention, the lens, light beam splitter and reflection element can be integrally formed.

In one embodiment of the present invention, the reflection element can be a prism or a reflective mirror.

In one embodiment of the present invention, the light source is a light emitting diode (LED) or a laser diode (LD).

In one embodiment of the present invention, the image sensor is a complementary metal oxide semiconductor (CMOS) image sensor or a charge coupled device (CCD).

Due to the fact that the illumination light beam is split into the first light beam and the second light beam by the light beam splitter, when the optical pointing device is put on the reflective surface, the first light beam is reflected to the image sensor, and when the optical pointing device is put on the transparent body which is disposed on the reflective surface, the second light beam is reflected to the image sensor. Therefore, the optical pointing device could achieve good sensitivity even if the optical pointing device is put on the transparent body disposed on the reflective surface.

### BRIEF DESCRIPTION OF THE DRAWINGS

These and other features and advantages of the various embodiments disclosed herein will be better understood with respect to the following description and drawings, in which like numbers refer to like parts throughout, and in which:

FIGS. 1A and 1B respectively show a conventional optical pointing device being put on an opaque body and being put on a transparent body.

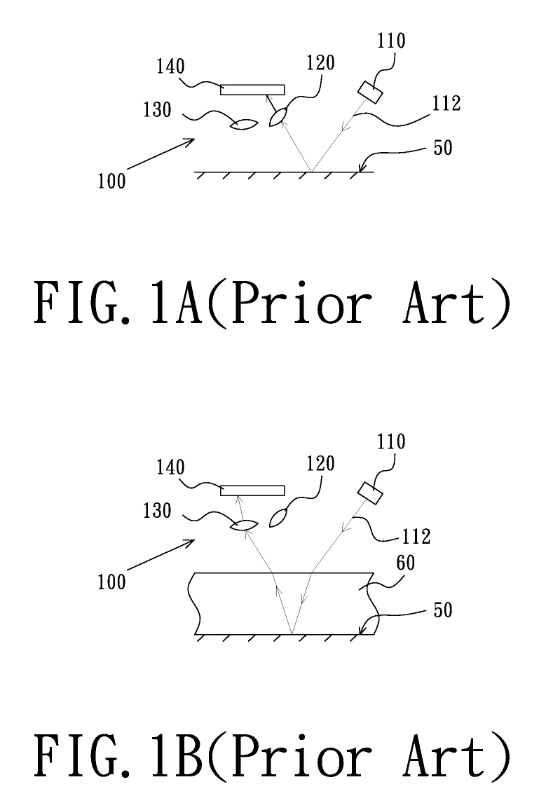

FIGS. 2A and 2B respectively show an optical pointing device, in accordance with an embodiment of the present invention, being put on an opaque body and being put on a transparent body.

FIG. 3 shows the light beam splitter, the reflection element and the lens are integrally formed.

### DETAILED DESCRIPTION

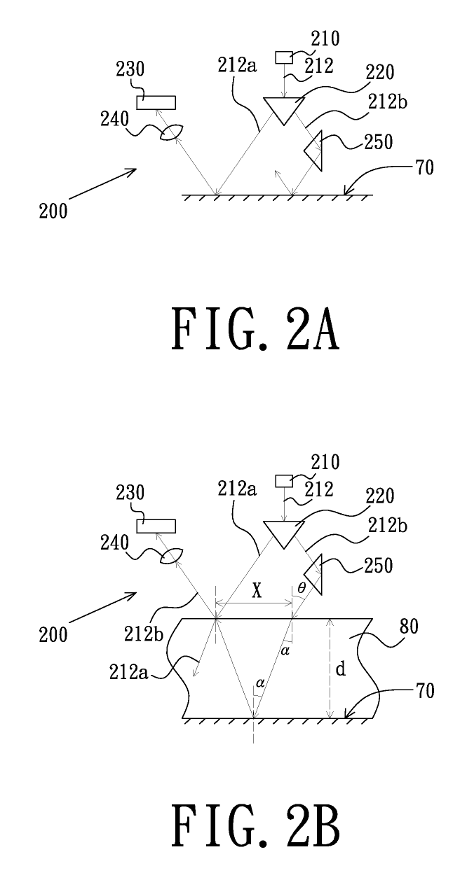

As illustrated in FIGS. 2A and 2B, the optical pointing device 200 is, but not limited to, an optical mouse. The optical pointing device 200 includes a light source 210, a light beam splitter 220, an image sensor 230 and a lens 240. The light source 210 is configured (i.e., structured and arranged) for providing an illumination light beam 212. The light beam splitter 220 is disposed on a transmission path of the illumination light beam 212 and configured for splitting the illumination light beam 212 into a first light beam 212a and a second light beam 212b. The image sensor 230 is configured for sensing the first light beam 212a and the second light beam 212b. The lens 240 is disposed before the image sensor 230.

In one embodiment, the light source 210 of the optical pointing device 200 can be a light emitting diode (LED) or a laser diode (LD). The image sensor 230 can be a complementary metal oxide semiconductor (CMOS) image sensor or a charge coupled device (CCD). Furthermore, the light beam splitter 220 as illustrated in FIGS. 2A and 2B can be a prism, or other light beam splitter such as a grating. In addition, the optical pointing device 200 can further include a reflection element 250. The reflection element 250 is disposed on a transmission path of the second light beam 212b and configured for reflecting the second light beam 212b to the reflective surface 70. The reflection element 250 as illustrated in FIGS. 21A and 2B can be a prism, or other reflection element such as a reflective mirror.

In order to allow the optical pointing device 200 to have good sensitivity at both of the circumstances of the optical pointing device 200 being put on a transparent body and being put on an opaque body, the light beam splitter 220 is used to split the illumination light beam 212 provided by the light source 210 into the first light beam 212a and the second light beam 212b. As illustrated in FIG. 2A, when the optical pointing device 200 is put on a surface (i.e., the reflective surface 70) of the opaque body, the first light beam 212a and the second light beam 212b are directly reflected by the reflective surface 70. The first light beam 212a is reflected to the lens 240 and then is focused on the image sensor 230 by the lens 240. In other words, when the optical pointing device 200 is put on the reflective surface 70 of the opaque body, the image sensor 230 can sense the first light beam 212a.

Referring to FIG. 2B, when a transparent body 80 (e.g., glass) is disposed on the reflective surface 70 and the optical pointing device 200 is put on the transparent body 80, the first light beam 212a and second light beam 212b would firstly pass through the transparent body 80 and then are reflected by the reflective surface 70. Thereafter, the first light beam 212a and second light beam 212b would exit from the transparent body 80. The first light beam 212a and second light beam 212b are refracted when entering into the transparent body 80 and exiting from the transparent body 80. The second light beam 212b is refracted to the lens 240 when exits from the transparent body 80 and then is focused on the image sensor 230 by the lens 240. In other words, when the optical pointing device 200 is put on the transparent body 80 disposed on the reflective surface 70, the image sensor 230 can sense the second light beam 212b.

A distance X between incident points of the first and second light beams 212a, 212b on the transparent body 80 and an incident angle θ of the first and second light beams 212a, 212b are in conjunction with a thickness d and a refractive index n1 of the transparent body 80. For example, the refractive index of air n2 is 1, if a given thickness d of the transparent body 80 is 1 centimeter (cm), a material of the transparent body 80 is silicon dioxide (refractive index n1=1.4568) and the incident angle θ is equal to 30 degree. According to Snell's law, the following expression is satisfied: n2×sin θ=n1×sin α. It is calculated from the above expression that sin α=0.343218 and X=2d×tan α=0.73083 cm.

In the present embodiment, by using the light beam splitter 220 to split the illumination light beam 212 provided by the light source 210 into the first light beam 212a and the second light beam 212b, when the optical pointing device 200 is put on the reflective surface 70, the image sensor 230 can sense the first light beam 212a, and when the optical pointing device 200 is put on the transparent body 80 which is disposed on the reflective surface 70, the image sensor 230 can sense the second light beam 212b. Therefore, the optical pointing device 200 in the present embodiment can achieve good sensitivity regardless of being put on the reflective surface 70 or being put on the transparent body 80 disposed on the reflective surface 70.

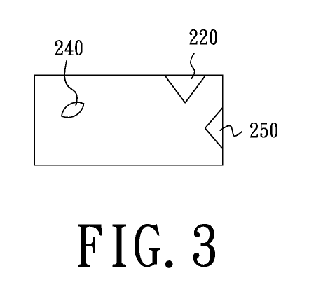

It is indicated that the above-mentioned lens 240, light beam splitter 220 and reflection element 250 can be integrally formed (as illustrated in FIG. 3), which facilitates the assembly of the optical pointing device 200 and therefore the production efficiency can be improved.

In summary, the optical pointing device in accordance with the present invention can achieve at least the following advantages.

(1) By using the light beam splitter to split the illumination light beam provided by the light source into two light beams, when the optical pointing device is put on the reflective surface or the transparent body which is disposed on the reflective surface, the image sensor can sense different light beams. Therefore, the optical pointing device has good sensitivity regardless of being put on the reflective surface or being put on the transparent body disposed on the reflective surface.

(2) Since the lens, the light beam splitter and the reflection element of the optical pointing device can be integrally formed, the assembly of the optical pointing device is facilitated and therefore the production efficiency can be improved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An optical pointing device, comprising:
a light source configured for providing an illumination light beam;
a light beam splitter disposed on a transmission path of the illumination light beam and configured for splitting the illumination light beam into a first light beam and a second light beam;
an image sensor configured for sensing the first light beam and the second light beam; and
a lens disposed before the image sensor;
wherein when the optical pointing device is put on a reflective surface, the first light beam is reflected to the lens by the reflective surface and then is focused on the image sensor by the lens; when the optical pointing device is put on a transparent body disposed on the reflective surface, the second light beam is reflected to the lens by the reflective surface and then is focused on the image sensor by the lens.

2. The optical pointing device as claimed in claim 1, wherein the light beam splitter is a prism or a grating.

3. The optical pointing device as claimed in claim 1, further comprising a reflection element disposed on a transmission path of the second light beam and configured for reflecting the second light beam to the reflective surface.

4. The optical pointing device as claimed in claim 3, wherein the lens, the light beam splitter and the reflection element are integrally formed.

5. The optical pointing device as claimed in claim 3, wherein the reflection element is a prism or a reflective mirror.

6. The optical pointing device as claimed in claim 1, wherein the light source is a light emitting diode or a laser diode.

7. The optical pointing device as claimed in claim 1, wherein the image sensor is a complementary metal oxide semiconductor image sensor or a charge coupled device.
